(19) United States
(12) Patent Application Publication
(10) Pub. No.: US 2025/0057076 A1
(43) Pub. Date: Feb. 20, 2025

(54) DUAL BLADE WIDE-FORMAT REAR-COLLECTION LAWN MOWER

(71) Applicant: YANGZHOU WEIBANG GARDEN MACHINE COMPANY LIMITED, Yangzhou (CN)

(72) Inventors: Jiaguo SHANG, Yangzhou (CN); Yi WU, Yangzhou (CN)

(21) Appl. No.: 18/640,363

(22) Filed: Apr. 19, 2024

(30) Foreign Application Priority Data
Aug. 15, 2023 (CN) 202322194908.8

(51) Int. Cl. A01D 34/685; A01D 34/73; A01D 34/76

(52) U.S. Cl. CPC A01D 34/685; A01D 34/73; A01D 34/76

(57) ABSTRACT

A dual blade wide-format rear-collection lawn mower including: a chassis, an engine mounted on an upper side of a rear portion of the chassis, and a grass cutter mounted on a lower side of a front portion of the chassis, the grass cutter includes a big grass cutter and a small grass cutter which are tangential to, and connected with, each other, a grass discharging channel is positioned at the side where the big grass cutter is located, and an entrance of the grass discharging channel is connected in a smooth transition manner with an out wall of the big cutter which is away from the small cutter, the grass discharging channel is tilted upward and backward and a grass discharging outlet thereof is connected with a grass collecting basket.

### FIELD OF THE INVENTION

The present invention relates to a lawn mower, and more specifically, to a dual blade wide-format rear-collection lawn mower, which can be classified as a garden machine.

### BACKGROUND OF THE INVENTION

With the requirements for city greening, lawn coverage becomes higher and higher, and artificial lawn planting industrial chain are thriving. Small-and medium-sized lawn mowing machines become widely used in many places such as parks, fields and turf planting bases. A conventional lawn mower comprises a chassis, an engine mounted on the chassis, and a grass cutter mounted under the chassis; the cutter is generally provided with a cutting blade that can be rotated at high speed; an output end of the engine crankshaft is mounted thereon with an engine pulley which drives a cutter shaft via a belt, thereby driving the cutting blade to rotate.

A lawn mower having only one cutting blade can cover a relatively small width in operation. In order to improve grass cutting efficiency, dual blade wide-format lawn mower emerged. A dual blade wide-format lawn mower employs two cutter shafts, with each cutter shaft mounted with a cutting blade on the lower end thereof. Conventionally, each of the two cutter shafts is mounted on the upper end thereof with a cutter shaft pulley which is driven by an engine pulley via a belt.

Chinese utility model patent publication number CN 210226224 U discloses a dual blade wide-format lawn mower wherein an engine is mounted on a chassis, and a grass cutter is provided under the chassis; the grass cutter comprises two cutter shafts parallel with each other; the two cutter shafts each are mounted with a cutting blade on an lower end thereof; the two cutter shafts each are mounted with a cutter shaft bevel gear on an upper end thereof, and each cutter shaft bevel gear is engaged with a transmission bevel gear mounted respectively on an outer end of a horizontal shaft; the two horizontal shafts are co-axial, and each horizontal shaft and the cutter shaft on the same side with said each horizontal shaft are supported respectively by a bearing in a cutter shaft seat; both cutter shaft seats are fixed onto the chassis, and opposing ends of the two horizontal shafts extend from the respective cutter shaft seat and each is mounted with a drum gear, and both drum gears are engaged respectively with spline internal teeth provided at both ends of an internally toothed sleeve; one cutter shaft has an upper end that extends from a top end of the respective cutter shaft seat and the upper end is mounted thereon with a cutter shaft pulley that is connected with an engine pulley via a cutter driving belt.

The two blades of the lawn mower of this patent can be used for simultaneous cutting at the same height; however, it has the following disadvantages:
1. For a small-sized gas engine-powered wide-format rear-collection walking lawn mower, the front half comprises the cutter, and the rear half is installed with the engine; where a compact structure is required, such an arrangement cannot avoid the interference of the grass discharging channel and the engine arranged thereabove.
2. The two cutting blades have the same diameter and completely symmetrical with each other; the two cutters of the same diameter discharge the grass backward from the middle thereof, and the angle of elevation of the discharge channel will be limited by the engine arranged thereabove, which makes the height of the outlet relatively small, and the flow rate and delivery speed of the channel cannot be guaranteed by the natural cyclone alone, resulting in possible clogging of the channel and the crushed grass is not able to enter the grass collecting basket completely, and thus exhibiting poor performance in grass collection.
3. Where an additional fan is used to assist backward grass discharging from one side of the cutters, the cost will be high and the machine will not be stable.

### SUMMARY OF THE INVENTION

It is an objective of the present invention to overcome the flaws present in prior art and provide a dual blade wide-format rear-collection lawn mower which can not only carry out grass cutting simultaneously at the same height with two interconnected blades, but also can ensure smooth grass discharge with natural air flow and achieve efficient grass collection.

For solving the technical problem described above, the present invention provides a dual blade wide-format rear-collection lawn mower comprising: a chassis, an engine mounted on an upper side of a rear portion of the chassis, and a grass cutter mounted on a lower side of a front portion of the chassis, wherein the grass cutter comprises a big grass cutter and a small grass cutter which are tangential to, and connected with, each other, the big grass cutter is provided with a long blade therein, and the small grass cutter is provided with a short blade therein, the long blade is fixed onto a lower end of a long blade shaft, and the short blade is fixed onto a lower end of a short blade shaft, both the long blade shaft and the short blade shaft are driven by the engine and rotated at the same direction, a grass discharging channel is positioned at a side where the big grass cutter is located, and an entrance of the grass discharging channel is connected in a smooth transition manner with an outer wall of the big cutter which is away from the small grass cutter, the grass discharging channel is tilted upward and backward and a grass discharging outlet thereof is connected with a grass collecting basket.

As an improvement of the invention, a vertical plane where the long blade shaft and the short blade shaft are located forms an angle with a width of the lawn mower, and the axis of the long blade shaft is closer to the rear side of the chassis than the axis of the short blade shaft.

As a further improvement of the invention, a deck of the grass cutter, the grass discharging channel and a seat plate of the engine are connected together as an integral part.

As a further improvement of the invention, the long blade shaft is installed on a top end thereof with a long blade shaft pulley set, and the short blade shaft is installed on a top end thereof with a short blade shaft belt wheel, and a short blade shaft idle pulley is installed over the short blade shaft belt wheel; a crankshaft of the engine is installed at a lower end thereof with a driving belt wheel for cutting, and the driving belt wheel for cutting is in transmission connection with the long blade shaft pulley set and the short blade shaft idle pulley via a first belt; and the long blade shaft pulley set is in transmission connection with the short blade shaft belt wheel via a second belt.

As a further improvement of the invention, the short blade shaft belt wheel has a diameter that is smaller than a diameter of the long blade shaft pulley set.

As a further improvement of the invention, the ratio of the diameter of the long blade shaft pulley set to the diameter of the short blade shaft belt wheel is equal to the ratio of the length of the long blade to the length of the short blade.

As a further improvement of the invention, the first belt has a loose side, the second belt has a loose side, and each loose side is pressed against a belt tension wheel.

As a further improvement of the invention, a driving belt wheel for walking is provided under the driving belt wheel for cutting, and the driving belt wheel for walking is integral with the driving belt wheel for cutting, the driving belt wheel for walking is in transmission connection with an input shaft belt wheel of a self-driving gear box via a third belt, and each end of an output shaft of the self-driving gear box is provided with a self-driving gear for driving the lawn mower to move.

As a further improvement of the invention, an arc brake plate is provided outside of the short blade shaft belt wheel, and an inner arc surface of the arc brake plate is configured to press against a backside of the second belt that is inserted in the short blade shaft belt wheel.

Compared to the prior art, the present invention has the following advantages:
1. The two grass cutters are designed to have a deviated rear-collection grass discharging channel, and the grass discharging channel and the engine are apart when viewed from the top, which effectively avoids a spatial interference between the grass discharging channel and the engine, the up-tilted angle and height of the outlet of the grass discharging channel will not be restricted by the engine, and the effective cross-sectional area of the grass discharging channel can be increased, thereby decreasing the resistance to the discharge of the grass and avoiding clogging.
2. In consideration of the deviated grass discharging channel, the two cutting blades are rotated in the same direction; since the ratio of the diameter of the long blade shaft belt wheel to the diameter of the short blade shaft belt wheel is equal to the ratio of the length of the long blade to the length of the short blade, the linear speed of the tip of the short blade is close to, or slightly greater than the linear speed of the tip of the long blade. The crushed grass cut by the rotation of the short blade at a higher speed enters the cyclone formed naturally by the high speed rotation of the long blade, thereby the crushed grass cut by both the long blade and the short blade are discharged in the same air flow smoothly and a satisfying grass collection can be achieved.

### BRIEF DESCRIPTION OF THE DRAWINGS

The present invention will be further described in detail by referring to the accompanying drawings. It should be understood that the accompanying drawings are merely used for description, but not for limiting the present invention.

FIG. 1 is a perspective view of the dual blade wide-format rear-collection lawn mower of the present invention;

FIG. 2 is a cross-sectional view of the dual blade wide-format rear-collection lawn mower of the present invention;

FIG. 3 is a bottom view of the dual blade wide-format rear-collection lawn mower of the present invention;

FIG. 4 is a perspective view of the chassis of the present invention;

FIG. 5 is a perspective view of the transmission mechanism of the present invention;

FIG. 6 is a cross-sectional view at the short blade shaft of the present invention; and in the figures:

### DETAILED DESCRIPTION OF THE INVENTION

In the description of the present invention provided below, the terms indicating directional or positional relationships such as “up”, “down”, “above”, “over”, “under”, “front”, “rear”, “left”, “right”, “inner”, “inside”, “outer” and “outside” are based on the directional or positional relationships shown in the accompanying drawings and used merely for facilitating the description of the present invention and making the description simple, but not for defining that the components must have the particular directions and/or positions.

In order to obtain a better understanding of the technical means, features for carrying out the invention and the objectives achieved therefrom, the invention will be further described below with reference to the accompanying drawings.

Unless otherwise defined, the technical and scientific terms used herein have the same meaning commonly understood by one skilled in the art. The terms used herein are merely used to describe the particular embodiments of the invention, but not intended to limit the scope thereof.

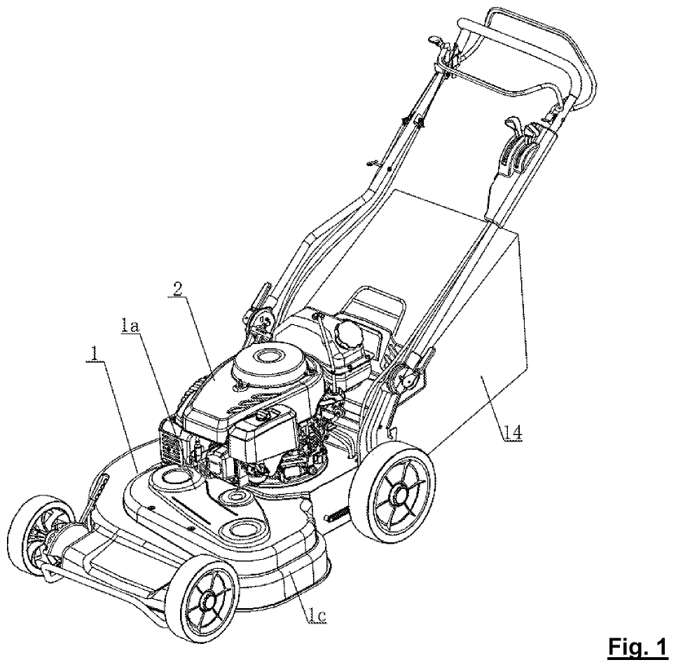

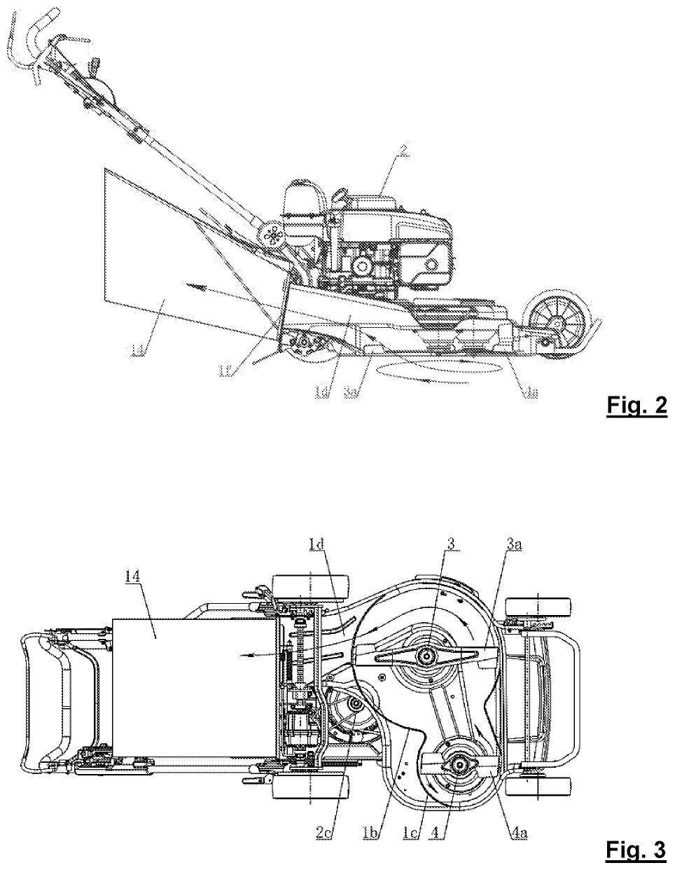

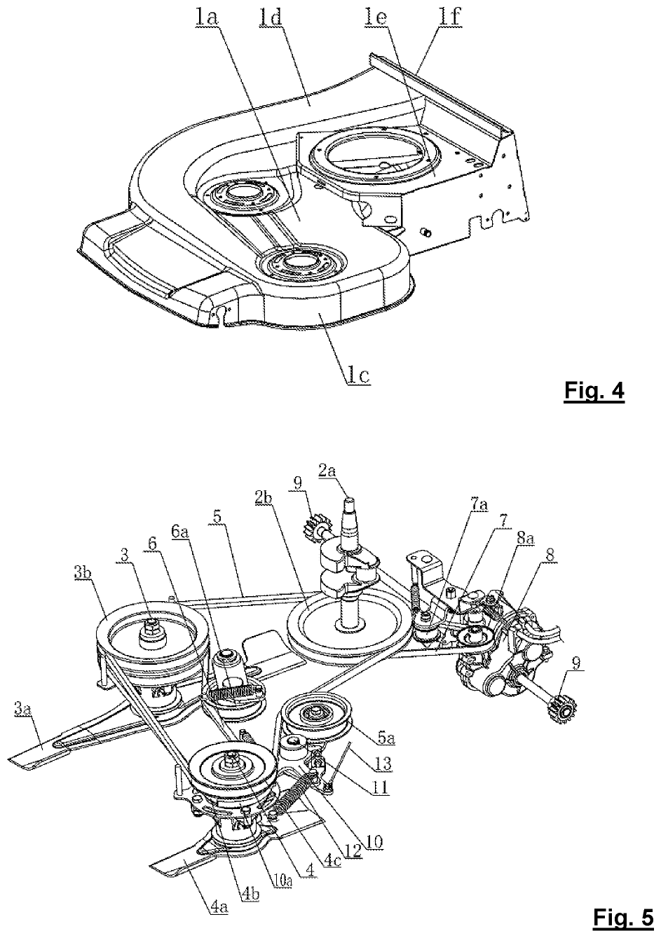

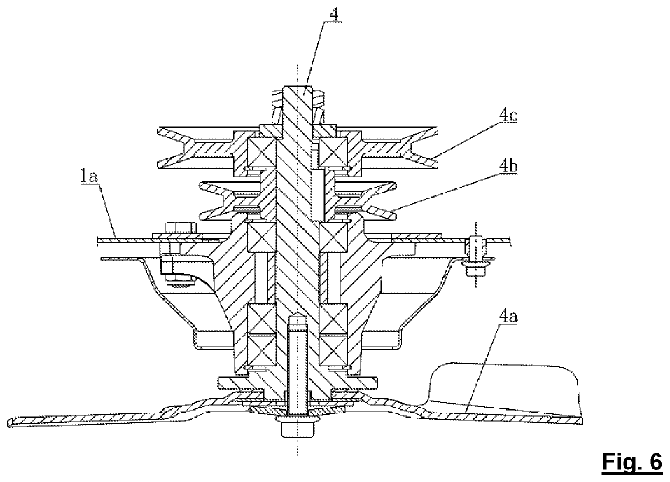

As shown in FIGS. 1-6, the dual blade wide-format rear-collection lawn mower of the present invention comprises a chassis 1, a grass cutter, an engine 2 and a grass collecting basket 14. The upper side of the rear portion of the chassis 1 is provided with an engine seat plate 1e with an engine 2 installed thereon. The lower side of the front portion of the chassis 1 is provided with the grass cutter, and the grass cutter comprises a big grass cutter 1b and a small grass cutter 1c which are tangential to, and connected with, each other. The big grass cutter 1b is provided with a long blade 3a therein, and the small grass cutter 1c is provided with a short blade 4a therein. The long blade 3a is fixed onto the lower end of the long blade shaft 3, and the short blade 4a s fixed onto the lower end of the short blade shaft 4.

The long blade shaft 3 is supported in a long blade shaft seat via a bearing, and the short blade shaft 4 is supported in a short blade shaft seat via a bearing. The peripheral of the upper portion of the long blade shaft seat and the peripheral of the upper portion of the short blade shaft seat each are provided with a blade shaft seat flange and the two flanges each are fixed under a grass cutter deck 1a by a bolt.

The chassis 1 is further provided with a grass discharging channel 1d. The grass discharging channel 1d is positioned at the side where the big grass cutter 1b is located, and the entrance of the grass discharging channel 1d is connected in a smooth transition manner with the out wall of the big cutter 1b which is away from the small cutter 1c. The grass discharging channel 1d is tilted upward and backward and the grass discharging outlet 1f at the backend thereof is connected with the grass collecting basket 14.

The long blade 3a and the short blade 4a are rotated in the same direction. The crushed grass cut by the high speed rotation of the short blade enters naturally, along the tangent direction, the cyclone formed naturally by the high speed rotation of the long blade 3a, and travels with the crushed grass cut by the long blade 3a into the grass discharging channel 1d, and then they enter the grass collecting basket 14 from grass discharging outlet 1f at the backend of the grass discharging channel 1d.

The vertical plane where the long blade shaft 3 and the short blade shaft 4 are located forms an angle with the width of the lawn mower. The axis of the long blade shaft 3 is provided closer to the rear portion of the chassis 1 than the axis of the short blade shaft 4 such that the length of the grass discharging channel 1d is shortened, thereby decreasing the resistance to the discharge of the grass.

The engine crankshaft 2a is provided at the lower end thereof with a driving pulley for cutting 2b, and a driving pulley for walking 2c is provided thereunder, and the driving pulley for walking 2c is integral with the driving pulley for cutting 2b.

The long blade shaft 3 is installed on the top end thereof with a long blade shaft pulley set 3b, and the short blade shaft 4 is installed on the top end thereof with a short blade shaft pulley 4b. A short blade shaft idle pulley 4c is installed over the short blade shaft pulley 4b.

The driving pulley for cutting 2b is in transmission connection with the long blade shaft pulley set 3b and the short blade shaft idle pulley 4c via a first belt 5 which is inserted in a first belt groove of the long blade shaft pulley set 3b. A first tension wheel 5a is provided between the short blade shaft idle pulley 4c and the driving pulley for cutting 2b, and the first tension wheel 5a is provided against the loose side of the first belt 5.

A second belt groove of the long blade shaft pulley set 3b is in transmission connection with the short blade shaft pulley 4b via a second belt. A second tension wheel 6a is provided against a loose side of the second belt 6. The diameter of the short blade shaft pulley 4b is smaller than the diameter of the long blade shaft pulley set 3b, such that the rotation speed of the short blade 4a is greater than the rotation speed of the long blade 3a.

As a preferable embodiment, the ratio of the diameter of the long blade shaft pulley set 3b to the diameter of the short blade shaft pulley 4b is equal to the ratio of the length of the long blade 3a to the length of the short blade 4a, such that the linear speed of the tip of the short blade 4a is equal to linear speed of the tip of the long blade 3a, which is more helpful for the crushed grass cut by the short blade 4a enters naturally, in the tangent direction, the cyclone formed by the high-speed rotation of the long blade 3a.

A arc brake plate 10a is provided outside of the short blade shaft pulley 4b, and the inner arc surface of the arc brake plate 10a is configured to press against the backside of the second belt 6 that is inserted in the short blade shaft pulley 4b. The base portion of the arc brake plate 10a is connected with the base portion of the brake arm 10 as an integral body, and the base portion of the brake arm 10 is a connecting end and hinged to the pivot 11. The free end of the brake arm 10 is in hinged connection with a brake-clutch pull cord 13 extending backward and a brake spring 12 extending forward. Additionally, the swing arm of the first tension wheel 5a can move together with the brake arm 10.

When the brake-clutch pull cord 13 is pulled backward, the brake arm 10 will rotate forward around the axis of the pivot 11, and with the release of the first tension wheel, the arc brake plate 10a is disengaged, or in a slight contact with the second belt 6. When the brake-clutch pull cord 13 is released, the pull force of the brake spring 12 will reset the arc brake plate 10a, that is, the arc brake plate 10a will be pressed against the backside of the second belt 6, and brake is achieved by the friction therebetween.

The driving pulley 2c for walking can be smaller than the driving pulley 2b for cutting, and accordingly, when they rotate at the same speed, the linear speed of the driving pulley 2c for walking will be smaller. The input shaft of the self-driving gear box 8 is mounted with a self-driving input pulley 8a, and the driving pulley 2c for walking is in transmission connection with the input pulley of the self-driving gear box 8 via a third belt 7, and the loose side of the third belt 7 is pressed against a third tension wheel 7a. Each of the two ends of the output shaft of the self-driving gear box 8 is provided with a self-driving gear 9. With the design descried above, one engine can not only drive the blades to cut, but also drive the lawn mower to move.

The embodiments described above are merely preferred ones for carrying out the present invention, which show and describe the basic principle, main features and advantages thereof, and they are not intended to limit the scope of the present invention. One skilled in the art would understand that the present invention should not be limited to the embodiments as described above. The present invention may also be implemented in other embodiments in addition to these embodiments without departing from the spirit and scope of the present invention. Various changes or modifications may be possible and all technical solutions obtained by equivalent replacements or equivalent modifications shall fall within the scope of the present invention. The scope of the present invention will be defined by the appended claims and the equivalents thereof. The features that are not described in this application can be carried out by or using prior art, and thus will not be repeated herein for brevity.

### Reference Signs

1 chassis
1a grass cutter deck
1b big grass cutter
1c small grass cutter
1d grass discharging channel
1e engine seat plate
1f grass discharging outlet
2 engine
2a engine crankshaft
2b driving pulley for cutting
2c driving pulley for walking
3 long blade shaft
3a long blade
3b long blade shaft pulley set
4 short blade shaft
4a short blade
4b short blade shaft pulley
4c short blade shaft idle pulley
5 first belt
5a first tension wheel
6 second belt
6a second tension wheel
7 third belt
7a third tension wheel
8 self-driving gear box
8a self-driving input pulley
9 self-driving gear
10 brake arm
10a arc brake plate
11 pivot
12 brake spring
13 brake-clutch pull cord
14 grass collecting basket

What is claimed is:

1. A dual blade wide-format rear-collection lawn mower comprising:
a chassis,
an engine mounted on an upper side of a rear portion of the chassis, and
a grass cutter mounted on a lower side of a front portion of the chassis,
wherein the grass cutter comprises a big grass cutter and a small grass cutter which are tangential to, and connected with, each other, the big grass cutter is provided with a long blade therein, and the small grass cutter is provided with a short blade therein, the long blade is fixed onto a lower end of a long blade shaft, and the short blade is fixed onto a lower end of a short blade shaft, both the long blade shaft and the short blade shaft are driven by the engine and rotated at the same direction, a grass discharging channel is positioned at a side where the big grass cutter is located, and an entrance of the grass discharging channel is connected in a smooth transition manner with an outer wall of the big cutter which is away from the small grass cutter, the grass discharging channel is tilted upward and backward and a grass discharging outlet thereof is connected with a grass collecting basket.

2. The dual blade wide-format rear-collection lawn mower according to claim 1, wherein a vertical plane where the long blade shaft and the short blade shaft are located forms an angle with a width of the lawn mower, and the axis of the long blade shaft is closer to the rear side of the chassis than the axis of the short blade shaft.

3. The dual blade wide-format rear-collection lawn mower according to claim 1, wherein a deck of the grass cutter, the grass discharging channel and a seat plate of the engine are connected together as an integral part.

4. The dual blade wide-format rear-collection lawn mower according to claim 1, wherein the long blade shaft is installed on a top end thereof with a long blade shaft pulley set, and the short blade shaft is installed on a top end thereof with a short blade shaft pulley, and a short blade shaft idle pulley is installed over the short blade shaft pulley; a crankshaft of the engine is installed at a lower end thereof with a driving pulley for cutting, and the driving pulley for cutting is in transmission connection with the long blade shaft pulley set and the short blade shaft idle pulley via a first belt; and the long blade shaft pulley set is in transmission connection with the short blade shaft pulley via a second belt.

5. The dual blade wide-format rear-collection lawn mower according to claim 4, wherein the short blade shaft pulley has a diameter that is smaller than a diameter of the long blade shaft pulley set.

6. The dual blade wide-format rear-collection lawn mower according to claim 5, wherein the ratio of the diameter of the long blade shaft pulley set to the diameter of the short blade shaft pulley is equal to the ratio of the length of the long blade to the length of the short blade.

7. The dual blade wide-format rear-collection lawn mower according to claim 4, wherein the first belt has a loose side, the second belt has a loose side, and each loose side is pressed against a belt tension wheel.

8. The dual blade wide-format rear-collection lawn mower according to claim 4, wherein a driving pulley for walking is provided under the driving pulley for cutting, and the driving pulley for walking is integral with the driving pulley for cutting, the driving pulley for walking is in transmission connection with an input shaft pulley of a self-driving gear box via a third belt, and each end of an output shaft of the self-driving gear box is provided with a self-driving gear for driving the lawn mower to move.

9. The dual blade wide-format rear-collection lawn mower according to claim 4, wherein an arc brake plate is provided outside of the short blade shaft pulley, and an inner arc surface of the arc brake plate is configured to press against a backside of the second belt that is inserted in the short blade shaft pulley.
